(19) United States
(12) Patent Application Publication
(10) Pub. No.: US 2021/0113988 A1
(43) Pub. Date: Apr. 22, 2021

(54) METHOD FOR PREPARATION OF CARBON DISULFIDE MODIFIED GRAPHENE OXIDE FOR Pb(II) ADSORPTION

(71) Applicant: University of Louisiana at Lafayette, Lafayette, LA (US)

(72) Inventors: Daniel Dianchen Gang, Lafayette, LA (US); Qiyu Lian, Lafayette, LA (US); Mark E. Zappi, Lafayette, LA (US)

(21) Appl. No.: 17/071,336

(22) Filed: Oct. 15, 2020

Related U.S. Application Data
(60) Provisional application No. 62/915,693, filed on Oct. 16, 2019.

(51) Int. Cl. B01J 20/20; B01J 20/32; B01J 20/30; C02F 1/28; B01D 15/20

(52) U.S. Cl. CPC B01J 20/205; B01J 20/3204; B01J 20/3234; C02F 2101/20; B01J 20/3071; C02F 1/283; B01D 15/20; B01J 20/3214

(57) ABSTRACT

This invention describes a novel method for adsorbing heavy metals and a novel adsorbent for same. In one embodiment, the method is used to specifically remove Pb(II). In one embodiment, the adsorbent comprises modified carbon disulfide (“CS₂”). In one or more embodiments the CS₂ is modified with a graphene derivative. In one or more embodiments the graphene derivative is graphene oxide (“GO”).

### CROSS REFERENCE TO RELATED APPLICATIONS

This application claims the benefit of U.S. Provisional Application No. 62/915,693 filed on Oct. 16, 2019 and entitled “Method for Preparation of Carbon Disulfide Modified Graphene Oxide for Pb(II) Adsorption.”

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### SUMMARY OF THE INVENTION

This invention provides a method for CS2 modification which introduces the more effective functional groups —(C═S)—S—H onto the surface of GO. This improves the performance of Pb(II) removal by exploiting the strong complexation between —(C═S)—S—H groups and Pb(II) in aqueous solution.

### DESCRIPTION OF THE DRAWINGS

The drawings constitute a part of this specification and include exemplary embodiments of the Method for Preparation of Carbon Disulfide Modified Graphene Oxide for Pb(II) Adsorption, which may be embodied in various forms. It is to be understood that in some instances, various aspects of the invention may be shown exaggerated or enlarged to facilitate an understanding of the invention. Therefore, the drawings may not be to scale.

FIG. 1 is a graphic demonstration of a preparation of GO.

FIG. 2 is a graphic demonstration of a preparation of GOCS.

FIG. 3 shows TEM images of GO and GOCS.

FIG. 4 shows SEM images and EDS scanning maps of GO and GOCS before and after Pb(II) adsorption.

FIG. 5(a) shows XRD patterns of GO and GOCS.

FIG. 5(b) shows FTIR spectra of GO and GOCS.

FIG. 5(c) shows the effects of pH on adsorption capacity (C₀=150 mg/L, S/L=3 g/L).

FIG. 5(d) shows point of zero charge (pH_{pzc}) of GO and GOCS.

FIG. 5(e) shows the effects of background cations (C₀=150 mg/L, pH=5.7, S/L=3 g/L),

FIG. 5(f) shows the effects of contact time and initial concentrations for GO and GOCS (pH=5.7, S/L=3 g/L).

FIG. 6(a) shows XPS spectra of survey.

FIG. 6(b) shows XPS spectra of C1s.

FIG. 6(c) shows XPS spectra of O1s for GO.

FIG. 6(d) shows XPS spectra of C1s.

FIG. 6(e) shows XPS spectra of O1s.

FIG. 6(f) shows XPS spectra of S2p for GOCS.

FIG. 7(a) is a graph of Pseudo-First-Order for GO.

FIG. 7(b) is a graph of Pseudo-First-Order for GOCS

FIG. 7(c) is a graph of Pseudo-Second-Order for GO.

FIG. 7(d) is a graph of Pseudo-Second-Order for GOCS.

FIG. 7(e) the Weber-Morris Intra-Particle Diffusion for GO.

FIG. 7(f) the Weber-Morris Intra-Particle Diffusion for GOCS.

FIG. 8(a) is a graph of adsorption isotherms at 298K (pH=5.7, S/L=3 g/L).

FIG. 8(b) is a graph of the Langmuir model.

FIG. 8(c) is a graph of the Freundlich model.

FIG. 8(d) is a graph of adsorption isotherms at 298K, 318K, and 333K.

FIG. 8(e) is the Van′t Hoff plot.

FIG. 8(f) shows regeneration capacity.

FIG. 9(a) shows XPS spectra of Pb4f, for GO after Pb(II) adsorption.

FIG. 9(b) shows XPS spectra of C1s, for GO after Pb(II) adsorption.

FIG. 9(c) shows XPS spectra of O1s, for GO after Pb(II) adsorption.

FIG. 9(d) shows XPS spectra of C1s, for GOCS after Pb(II) adsorption.

FIG. 9(e) shows XPS spectra of O1s, for GOCS after Pb(II) adsorption.

FIG. 9(f) shows XPS spectra of S2p, for GOCS after Pb(II) adsorption.

### BACKGROUND

Since the dawn of the industrial revolution, heavy metal contamination from industrial activities, such as mining, smelting, electroplating, and other agricultural activities, have posed environmental threats. Pb(II) has been listed as one of the most pernicious contaminants, due to its oncogenicity, bio-accumulation, non-biodegradability, and virulence. Even low amounts of Pb(II) in the human body can create serious illness. The World Health Organization (WHO) has established 0.01 mg/L as the maximum permissible limit of Pb(II) in drinking water. Therefore, Pb(II) removal from drinking water has gained more and more attentions from researchers.

Currently, various technologies have been applied to eliminate Pb(II) contamination, such as chemical precipitation, membrane filtration, solvent extraction, electrocoagulation, and ions exchange. However, these technologies exhibit common constraints, including excessive operation time, high initial cost of installation, and high energy consumption.

“Adsorption technique” is one of the popular technologies used to remove Pb(II) from drinking water. A variety of adsorbents have been applied to remove Pb(II) efficiently from aqueous solutions, including natural materials, synthetic materials, nano-materials, and biomaterials. For instances, the prior art has examined the efficiency of chitosan, as a natural adsorbent for Pb(II) removal from aqueous solution with the maximum adsorption capacity of 42.3 mg/g. A synthetic material, TiO₂ functionalized with hydroxide ethyl aniline (PHEA/n-TiO₂), was applied for Pb(II) removal with the optimum adsorption capacity of 26.05 mg/g.

A nanocomposite, poly(acrylamide-co-itaconic acid)/MWCNTs, was synthesized by the prior art to remove Pb(II) with the maximum adsorption capacity of 93.85 mg/g. In other instances, the prior art has fabricated the polyethyleneimine-bacterial cellulose as the bioadsorbent for Pb(II) removal with a maximum adsorption capacity of 141 mg/g.

However, these adsorbents addressed by the prior arts have limitations in either adsorption capacity or regeneration which weakens their potential in the application of Pb(II) removal. All these drawbacks drive the need to explore a novel adsorbent for Pb(II) removal.

Graphene oxide (“GO”), a newly-developed graphene derivative, has been studied because of its structure and the variety of abundant oxygen-containing functional groups on the edge of its surface. These various oxygen-containing functional groups, including: carboxyl (“COOH”), hydroxyl (“C—OH”), and epoxy (“C—O—C”) groups, distinguish GO as an advanced and practical adsorbent for the adsorption of heavy metal ions and organic pollutants via complexations or redox reactions. However, the layers of GO can be irreversibly aggregated or polymerized due to the strong interplanar reciprocities existing in GO, which can incur the obvious reduction of the BET surface area and hinder the effective adsorption performance by reducing the adsorption capacity. The prior art provides a variety of modified GO by introducing the specific functional groups, such as thiol functionalized graphene oxide, magnetic dithiocarbamate functionalized reduced graphene oxide, β-cyclodextrin modified magnetic graphene oxide, which can significantly improve the affinity towards the heavy metal ions.

Various carbon disulfide (“CS₂”) modified materials have been fabricated as an effective adsorbent, such as CS₂ modified thiourea chitosan and CS₂ modified alkaline lignin, for Pb(II), Ni(II), Cd(II), and Zn(II) removal. After CS₂ modification, the adsorption capacity of the adsorbents can be significantly improved, due to the introduction of specific functional groups (—(C═S)—S—H) on the surface of the adsorbents. However, there has been few advances regarding CS₂ modified GO (“GOCS”) as the adsorbent for Pb(II) removal and, moreover, the adsorption mechanism between Pb(II) and CS₂ modified GO is still unknown.

This invention provides a method for CS₂ modification which introduces the more effective functional groups —(C═S)—S—H onto the surface of GO. This improves the performance of Pb(II) removal by exploiting the strong complexation between —(C═S)—S—H groups and Pb(II) in aqueous solution. This invention addresses the short comings of the prior art by meeting the following aims (1) to fabricate GO and GOCS and characterize the surface and textural properties of GO and GOCS by SEM, EDS, TEM, XRD, FTIR, and XPS, (2) to provide the adsorption behavior of GO and GOCS for Pb(II) removal by varying initial concentration, pH, contact time, and temperature, (3) to provide the performance of GOCS in the presence of background cations and regeneration behavior, (4) to provide the other improvement concerning the Pb(II) adsorption mechanism based on the XPS and FT-IR spectra analysis. In short, this invention is a new effective and novel adsorbent for the application of Pb(II) adsorption.

### DETAILED DESCRIPTION

The subject matter of the present invention is described with specificity herein to meet statutory requirements. However, the description itself is not intended to necessarily limit the scope of claims.

Furthermore, the described features, structures, or characteristics may be combined in any suitable manner in one or more embodiments.

This invention describes a novel process for adsorbing heavy metals and a novel adsorbent for same. In one embodiment, the method is used to specifically remove Pb(II). In one embodiment, the adsorbent comprises modified carbon disulfide (“CS₂”). In one or more embodiments, the CS₂ is modified with a graphene derivative. In one or more embodiments, the graphene derivative is graphene oxide (“GO”).

### Example

Graphite flakes, sodium nitrate (NaNO₃, ≥99.0%), and hydrogen peroxide (H₂O₂, 30%) were obtained from Sigma Aldrich. Potassium permanganate (KMNO₄, 99+%) was obtained from Acros Organics. Sulfuric acid (H₂SO₄, 95.0%-98.0%) was obtained from VWR Scientific. Sodium hydroxide (NaOH, 98.1%) and lead(II) nitrate (Pb(NO₃)₂, 99.99%) were obtained from Fisher Scientific.

Synthesis of GrapheneOxide (GO) and CS₂ Modified GO (GOCS)

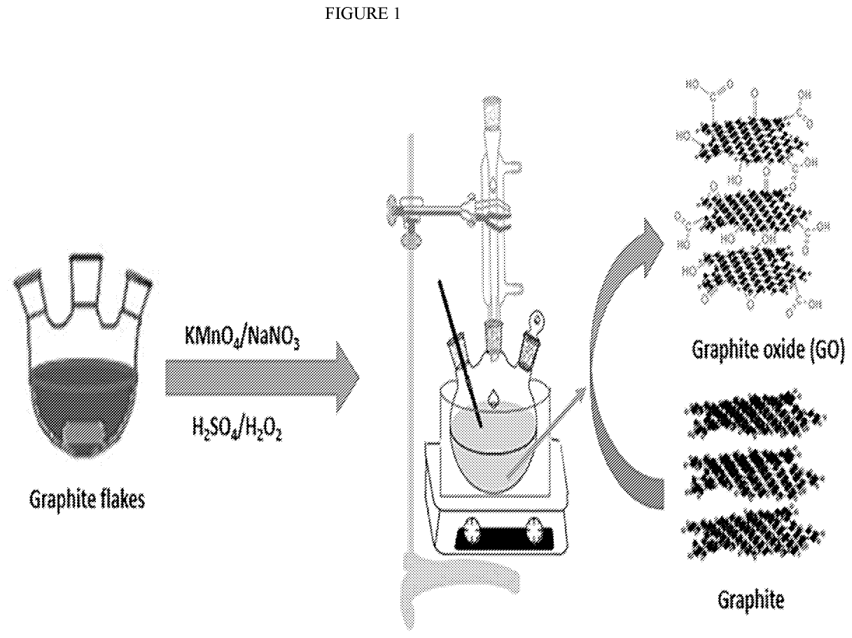

Grapheneoxide was synthesized by the oxidation of the graphene flakes via the modified Hummer's method. Three (3.0) grams (g) of graphite flakes were mixed with 3 g of NaNO₃ by stirring and 138 mL of H₂SO₄ was added. The reaction was done in an ice bath for 30 min. The mixture was oxidized by adding 18 g of KMnO₄ and stirred for another 30 min under the same condition. The temperature was raised and maintained at 35±5° C. for 24 hours to complete oxidation of the graphite. A volume of 240 mL of water was added and the mixture was continuously stirred for 30 min while the temperature was increased and maintained at 90±5° C. After that, 18 mL of H₂O₂ was added and the solution was cooled down to room temperature. The product was centrifuged at 10,000 rpm for 10 minutes and the pellet was collected. The solids were washed with 1.0 M HCl (300 mL) twice. The subsequent washings with DI water were done to neutralize the pH of the final product. The final product was dried at 85° C. in the oven and denoted as GO. The preparation steps of GO were shown in FIG. 1.

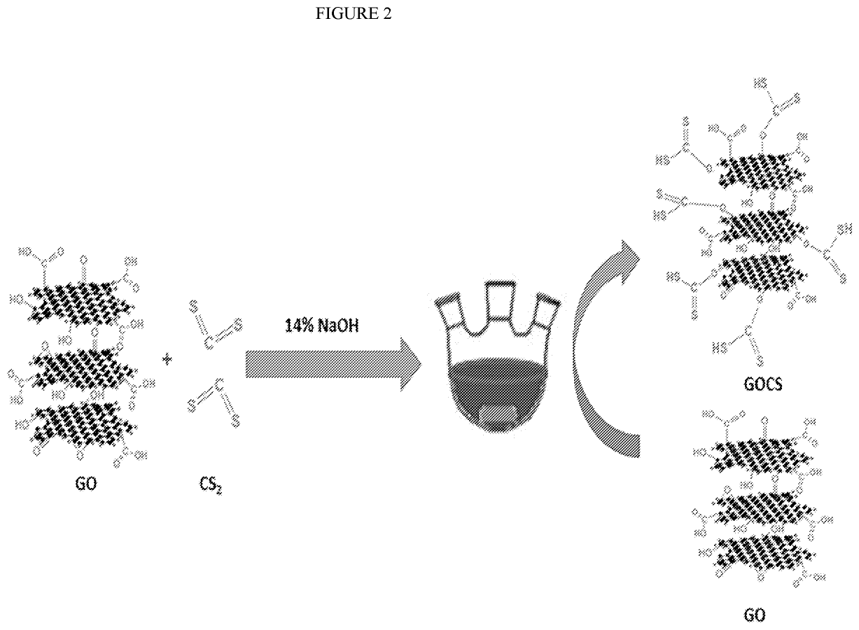

CS₂ modified GO was prepared: 0.2 g of GO was mixed with 14% 10 ml NaOH and then 4 ml CS₂ was added into the mixture under stirring for 24 h at the room temperature. Additional 4 ml CS₂ was added into the mixture under same condition for another 24 h. Next, the mixture was washed by DI water until the pH was neutralized and then sequently washed by methanol 3 times. Finally, the product was dried in the oven and denoted as GOCS. The synthesis procedure of GOCS is shown in FIG. 2.

Characterization

The FTIR spectra were measured by scanning from 4,000 to 400 cm⁻¹ with Jasco 4700 Fourier Transform Infrared Spectroscopy. The mass ratio of adsorbent to KBr was maintained at 1:100. The XPS spectra were obtained by Scientaomicror ESCA 2SR XPS System. Spectra were collected with monochromatic Al Ka X-ray source (hυ=1486.6 eV) operated at 600 W with the base pressure of 1×10⁻⁹ mbar in the analysis chamber. The deconvolution of the spectra were conducted using CasaXPS software. The SEM images were obtained from a JEOL 6300 Field Emission Scanning Electron Microscopy with the acceleration voltage of 15 kV and 15 nm of gold coated samples and the map scanning of the main elements on the surface of the sample were also conducted at the same time. TEM images were obtained from a Hitachi 7600 Transmission Electron Microscopy. The acceleration voltage used was 100 kV. The samples were prepared by dispersing a large number of particles in ethanol with an ultrasonic bath for 1 h and a drop of the resulting suspension were placed on a Cu grid. The XRD patterns were determined by The DIANO 2100E X-ray Diffractometer with Cu-Kα at 40 kV and 30 mA. The operating conditions were that 20 ranged from 5° to 80° at a rate of 1°/min in 0.02° increments.

Batch Adsorption Study

The amount of 30 mL Pb(II) solution of 150 mg/L was placed in 40 mL glass vials. One blank sample without any absorbents (GO and GOCS) was prepared and treated under the same condition as the adsorption samples in each batch of the adsorption experiments. This blank sample was considered as a reference control in every batch experiment. The kinetics of Pb(II) adsorption were studied with an initial concentration of 150, 200, and 250 mg/L. The pH effects were studied in the pH range from 2 to 7. The thermodynamics of Pb(II) adsorption were investigated at the temperature of 25, 45, and 60° C. The samples were placed in the shaker (Excella E24 Incubator Shaker) and agitated at 275 rpm for 24 hours. After shaking, the vials were removed and solutions were filtered by a 0.45 μm syringe filter.

The adsorption capacity of GO and GOCS, Qₑ (mg/g), at the equilibrium condition was calculated by the following equation:

$${Q}_{e} = \frac{( {C}_{i} - {C}_{e} ) \times V}{M} \qquad ( 1 )$$

where, Cᵢ is the initial concentration of absorbate (mg/L); Cₑ is the final concentration of adsorbate at equilibrium (mg/L); V is the volume of the solution (L); M is the mass of the absorbent (g).

However, the adsorption capacity at pre-determined time intervals was calculated by using the following equation:

$${Q}_{t} = \frac{( {C}_{i} - {C}_{t} ) \times V}{M} \qquad ( 2 )$$

where, Cₜ is the concentration of adsorbate (mg/L) at time t (min).

Regeneration Study

In this study, five regeneration cycles were conducted following the batch of adsorption and desorption studies under the same criteria. The procedures of the adsorption experiments are same with the batch adsorption study. The experiments of desorption were implemented using 0.1M HNO₃ to treat the adsorbed adsorbents. The procedures of the desorption experiments are as follows: first, 30 mL 0.1M HNO₃ solution was added into 40 mL vial with all the collected adsorbed adsorbents. Then, the vial was placed in the shaker at 275 rpm for 24 hours under 25° C. The adsorption and desorption experiments were consecutively repeated five times to complete the five generation cycles.

TEM Images

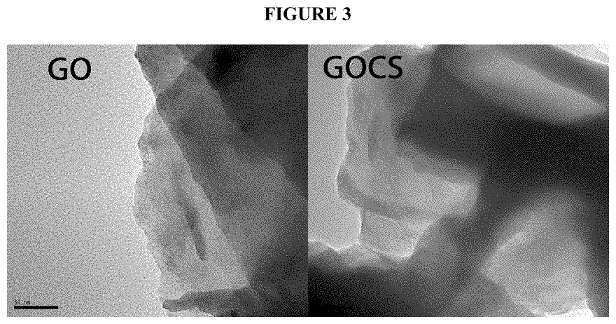

The TEM images for GO and GOCS are shown in FIG. 3. The nanosheets of GO were overlapped together, which can be identified by the edges of nanosheets, probably due to the graphite used to synthesize the GO. Similarly, the nanosheets of GOCS were smoother and relatively more aggregated than that of GO and certain winkles were observed on the nanosheets of GOCS. These observations suggested that the CS₂ modification treatment could result in the change on the surface of GOCS.

SEM Images and EDS Scanning Map

As shown in FIG. 4, SEM images of GO and GO after Pb(II) adsorption in illustrated a flat and smooth morphology with certain cracks. The morphology of GOCS and GOCS after Pb(II) adsorption exhibited rougher than that of GO and GO after Pb(II) adsorption indicating that CS₂ modification had the significant effects on the morphology. The morphology of both of GO and GOCS after Pb(II) adsorption showed no significant change compared with that of GO and GOCS. FIG. 4 shows the map scanning of C and O for GO interpreting the presence of abundant oxygen in GO and the map scanning of C, O, and S confirmed the existence of sulfur in GOCS which can be ascribed to CS₂ modification. The map scanning of Pb(II) in both of GO and GOCS after Pb(II) adsorption indicated Pb(II) was adsorbed onto GO and GOCS successfully.

XRD Pattern

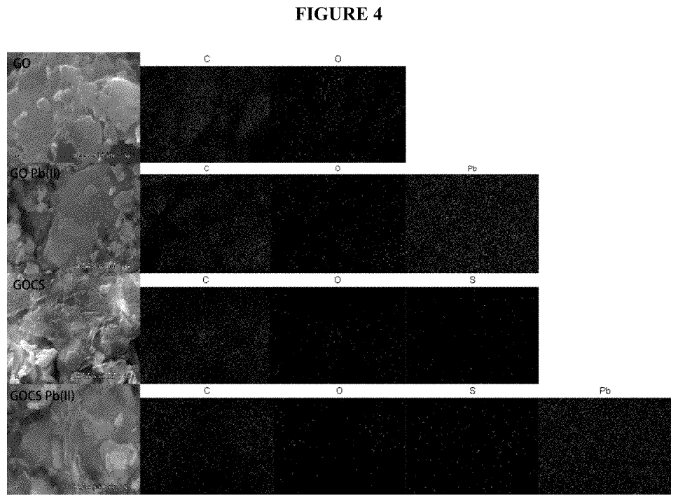

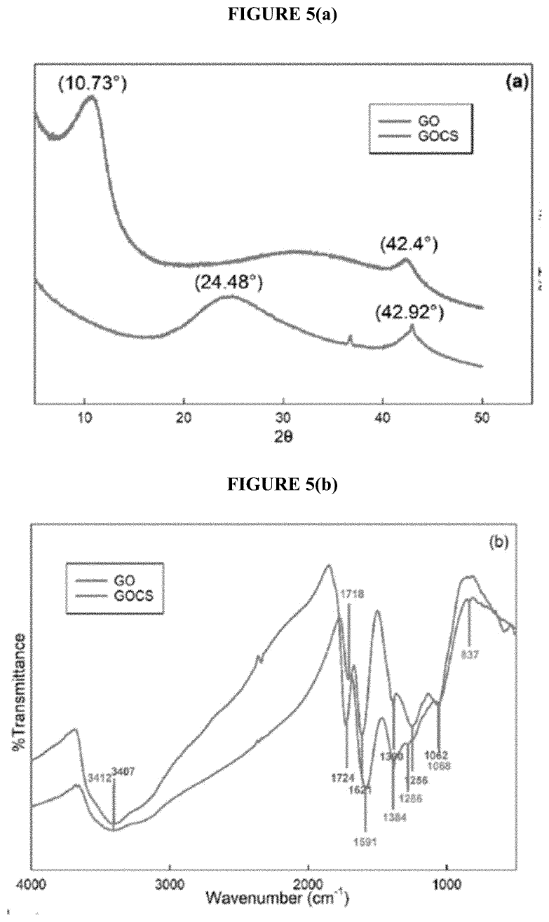

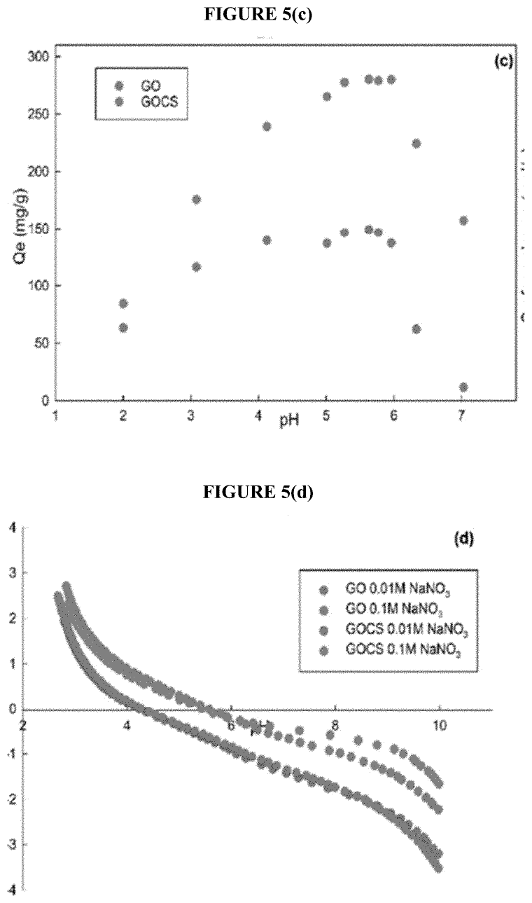

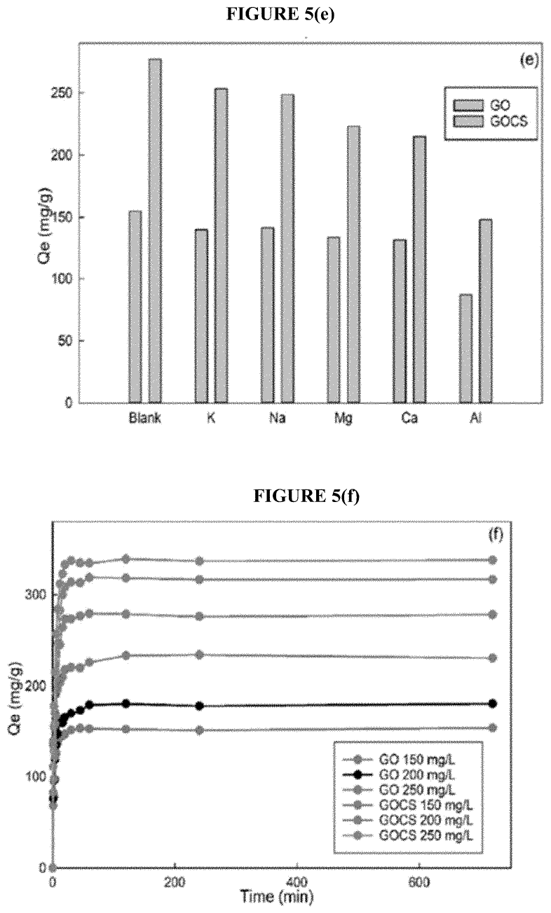

The XRD patterns of GO and GOCS are displayed in FIG. 5(a). From the results, the main characteristic peaks for GO and GOCS were at 2θ=10.73° and 2θ=24.48° corresponding to (001) and (002) reflections, respectively. The presence of peaks at 2θ=42.4° on GO and 2θ=42.92° on GOCS indicate a short-range order stacked graphene layers. The peak at 2θ=24.48° exists in XRD patterns of GOCS was the (002) reflection of the lower degree oxidation of periodicity of stacking in GOCS. The absence of the peak at 2θ=10.73° in GOCS indicates that some of the oxygen-containing functional groups were reduced in GOCS compared with that of GO, which could be attributed to the introduction of the —O—C(═S)—S— group on GOCS after functionalization. Similar observations have been reported in the literature.

Fourier Transform Infrared Spectroscopy (FT-IR)

The FTIR spectra of GO and GOCS are shown in FIG. 5(b). The spectrum of GO exhibits the characteristic peaks at 1256 and 1062 cm⁻¹ corresponding to the epoxy groups associating with the symmetric stretching and deformation vibrations. In addition, the peaks at 1724, 1621, and 1390 and 3412 cm⁻¹ were ascribed to the vibrations of C═O, C═C, C—O, and O—H and adsorbed water, respectively, which are in good agreement with the results reported in the literature. Due to the hypothesis that the CS₂ can react with oxygen-containing functional groups to form the functional —O—C(═S)—S— groups. The presence of these functional groups can be ascribed to the peaks in the range of 1250-1200, 1140-1110, and 1070-1020 cm′. The —O—C(═S)—S— groups could overlap with the stretching vibrations from oxygen-containing groups in the FTIR spectra of GO. However, some changes in the location, shapes, and relative intensity of the peaks associated to the bonds of C═O (1718 cm⁻¹), C—O (1384 cm⁻¹), and epoxy groups (1286 and 1068 cm⁻¹) were observed and a new peak appeared in the spectrum of GOCS. The left shift and little reduction of the intensity of the peaks at 1286 and 1068 cm⁻¹ were attributed to the formation of the functional —C(═S)—S— groups. The new peak at 837 cm⁻¹ was associated to the vibration of C—S bond. All these results confirmed that the new functional —C(═S)—S— groups were successfully introduced onto the surface of GO after CS₂ functionalization.

XPS Spectra

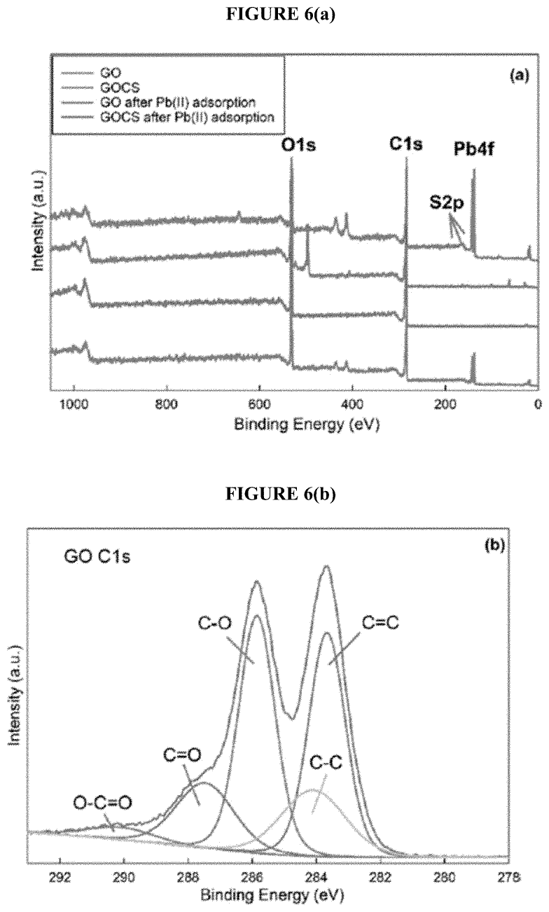

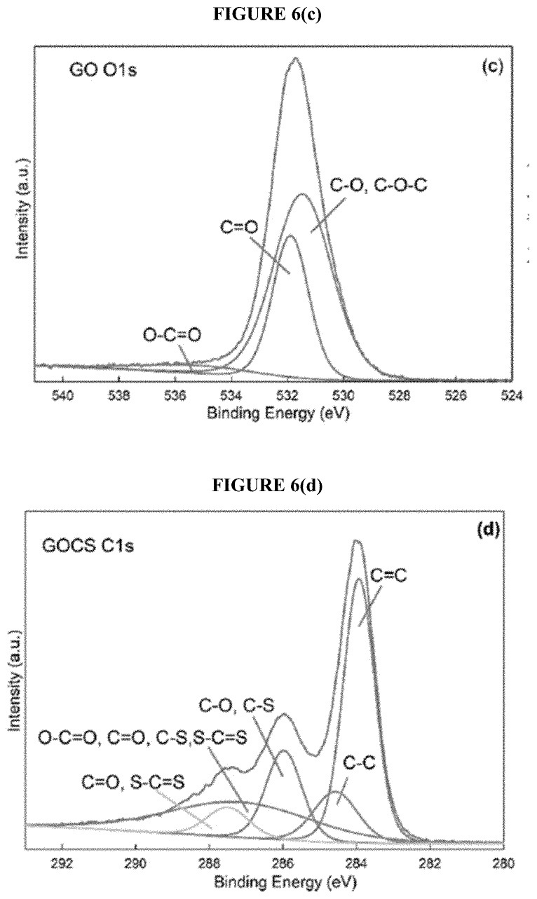

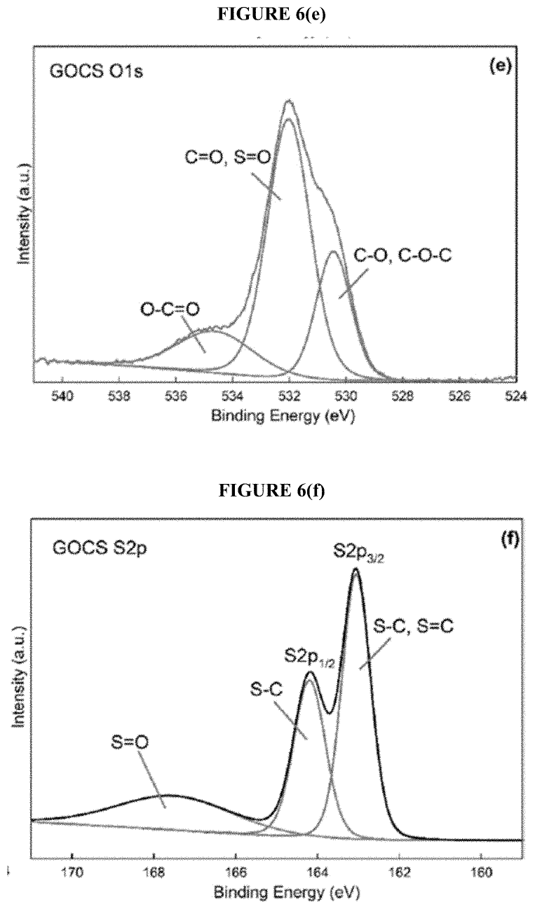

The analysis of XPS spectra was conducted to investigate the chemical coordination of individual elements existing in GO and GOCS. The XPS survey spectra (FIG. 6(a)) display the common peaks of C1s and O1s in all the samples. The new peak of S2p was found in the survey spectrum of GOCS before and after Pb(II) adsorption probably due to the CS₂ functionalization. The spectra of GO and GOCS after Pb(II) adsorption exhibit a strong signal peak of Pb4f confirming Pb(II) was adsorbed onto the GO and GOCS successfully. FIG. 6(b) shows that the deconvolution of the C1s electrons of GO yielded five peaks at the binding energies of 283.7, 284.1, 285.9, 287.5, and 290.2 eV corresponding to C═C, C—C, C—O, C—O, C═O and O—C═O, respectively. The spectrum of O1s (FIG. 6(c)) in GO was deconvoluted to three peaks at the binding energies of 531.5, 531.9, and 535.4 eV associated to C—O, C═O, and O—C═O, respectively. Similarly, the spectrum of C1s (FIG. 6(d)) of GOCS was fitted to five peaks at 283.9, 284.6, 286.0, 287.6, and 287.2 eV corresponding to C═C, C—C, C—O and C—S, C═O and S—C═S, and O—C═O and S—C═S, respectively. Meanwhile, the spectrum of O1s (FIG. 6(e)) in GOCS was deconvoluted to three peaks at 530.4, 532.0, and 534.8 eV associated to C—O, C═O and S═O, and O—C═O, respectively. The deconvoluted peaks of C1s and O1s in GOCS showed the slight shifting in location confirming the formation of new bonds with sulfur compared with those in GO, which was possibly attributed to the newly formed C—S bonds in GOCS. This conclusion can be confirmed by the presence of new spectrum of S2p (FIG. 6(f)) in GOCS, which was deconvoluted to three peaks at 163.1, 164.2, and 167.6 eV. The first two peaks signified the incorporation of sulfur into the graphitic matrix forming C—S bonds assigning to the S2p_{3/2} and S2p_{1/2} whereas the last one may be assigned to the oxidized sulfur species. These observations were in good agreement with the FTIR spectrum of GOCS indicating that the functional groups of —C(═S)—S— were successfully incorporated into GOCS by CS₂ functionalization.

Effects of pH

A batch of Pb(II) adsorption experiments with the initial concentration of 150 mg/L were implemented by varying the pH values from 2.0 to 7.0. As shown in FIG. 5(c), the optimal pH condition was observed at pH=5.7 which contributes to a highest Pb(II) adsorption capacity of 149.07 and 280.2 mg/g for GO and GOCS, respectively. The Pb(II) adsorption capacity for GO and GOCS increased from 63.3 to 149.07 mg/g and 84.33 to 280.2 mg/g, respectively, with the increase of pH value below 5.7. When the pH reached around 6, the obvious precipitation was observed by forming the insoluble hydrolyzed species Pb(OH)₂, which has already been reported by the literature. The significant effects of pH values on the Pb(II) adsorption performance were attributed to the influence of the surface charge of the adsorbents besides controlling other factors such as metal speciation, sequestration, and mobility. From FIG. 5(d), the surface charge of GO and GOCS became progressively more negative with the increase of pH from 2.0 to 7.0. The improved negativity of the surface charge of the adsorbents at higher pH value enhanced the Pb(II) adsorption performance by deprotonating the functional groups of GO and GOCS as H⁺ and H₃O⁺ released from them. This statement can be supported by the results of effects of pH. The pH_{pzc} of GO and GOCS was found to be 4.2 and 5.4, respectively. The larger pH_{pzc} of GOCS compared to GO was probably due to the replacement of —OH group by —O—C(═S)—S— group after CS₂ modification, which can be supported by FTIR and XPS results. At the pH<pH_{pzc}, the repulsive force existing between Pb(II) species and positively charged binding sites of GO and GOCS in conjunction with competed H⁺ and H₃O⁺ resulted in hindering the efficiency of Pb(II) adsorption. At the pH>pH_{pzc}, the negatively charged binding sites of GO and GOCS electrostaticly attracted Pb(II) species promoting a higher Pb(II) adsorption capacity and the optimal pH value of 5.7 was found in this condition. The similar results have been reported in the literature.

Effects of Background Cations

Various background cations, such as Na⁺, K⁺, Ca²⁺, Mg²⁺, and Al³⁻, were conducted to study their effects on Pb(II) adsorption onto GO and GOCS. From FIG. 5(e), the monovalent cations (Na⁺ and K⁺) have almost no influence on Pb(II) adsorption performance for both GO and GOCS. On the other hand, the Pb(II) adsorption capacity in the divalent cations (Ca²⁺ and Mg²⁺) system exhibited the average reduction of 14.5% and 20.9% for GO and GOCS, respectively. However, the reductions of 43% and 46.5% in Pb(II) adsorption capacity in Al³⁺ system for GO and GOCS, respectively, indicate the significant effects onto the Pb(II) adsorption performance. The possible reason is that the strong ion-dipole force formed between water molecules and Na⁺, K⁺, Ca²⁺, and Mg²⁺ hindering the electrostatic interaction with the functional groups of GO and GOCS, which correspondingly exhibited the limited effects on Pb(II) adsorption performance. However, the relatively weaker ion-dipole force formed between water molecules and Al³⁺ resulted in the competition with Pb(II) to electrostaticly interact with the functional groups of GO and GOCS.

Effects of Contact Time and Initial Concentrations

FIG. 5(f) shows the effects of adsorption contact time on the Pb(II) adsorption performance by GO and GOCS at three Pb(II) initial concentrations of 150, 200, and 250 mg/L. As shown in FIG. 5(f), the increase of the adsorption capacity was observed at the initial fast stage in first 15 mins followed by the second slow stage for both of GO and GOCS. However, the equilibrium time of 30 mins for GOCS was much less than 60 mins for GO, which indicated that the addition of CS₂ modification significantly accelerated the adsorption process to reach equilibrium. This phenomenon could be explained by the effect that the introduced functional groups of —O—C(═S)—S— led GOCS to expose more active sites to interact with Pb(II) species.

As shown in FIG. 5(f), the equilibrium adsorption capacity of GO and GOCS for Pb(II) adsorption increased significantly with the increase of the initial concentrations from 150 to 250 mg/L. The 53% and 21% increment in equilibrium adsorption capacity were observed for GO and GOCS, which were from 152.97 to 234.09 mg/g and 278.67 to 337.8 mg/g, respectively. The possible reason for this phenomenon is that the higher initial concentration showed the stronger driving force to react with the anchoritic active sites existing on the surface of GO and GOCS. In addition, the equilibrium adsorption capacity for GOCS showed the 83.2% and 44.3% increment compared with that for GO at the Pb(II) initial concentration of 150 and 250 mg/L, respectively, indicating that GOCS performed a stronger and faster adsorption behavior than GO at lower Pb(II) initial concentration.

Adsorption Kinetics

In order to understand if the Pb(II) adsorption process onto GO and GOCS was physical adsorption or chemical adsorption, the Pseudo-First-Order and Pseudo-Second-Order kinetic models were investigated. The Weber-Morris Intra-Particle Diffusion model was applied to determine the effects of rate controlling steps. The three models of Pseudo-First-Order (Eq. 3), Pseudo-Second-Order (Eq. 4), and the Weber-Morris Intra-Particle Diffusion (Eq. 5) can be expressed as below:

$$\begin{matrix}ln ( {Q}_{e} - {Q}_{t} ) = ln {Q}_{e} - \frac{{k}_{1}}{2.303} \cdot t & ( 3 ) \\ \frac{t}{{Q}_{t}} = \frac{1}{{k}_{2} {Q}_{e}^{2}} + \frac{t}{{Q}_{e}} & ( 4 ) \\ {Q}_{t} = {k}_{3} {t}^{1 \text{/} 2} + C & ( 5 )\end{matrix}$$

where, Qₜ and Qₑ were the Pb(II) adsorption capacity at any time t (min) and equilibrium, respectively. k₁, k₂, and k₃ were the rate constants for models of Pseudo-First-Order, Pseudo-Second-Order, and Weber-Morris Intra-Particle Diffusion, respectively. C is the constant for Weber-Morris Intra-Particle Diffusion model.

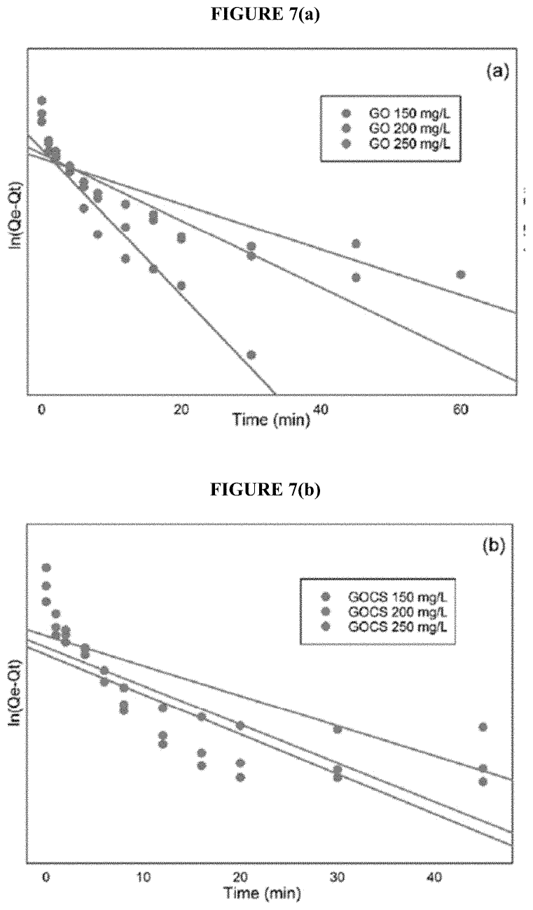

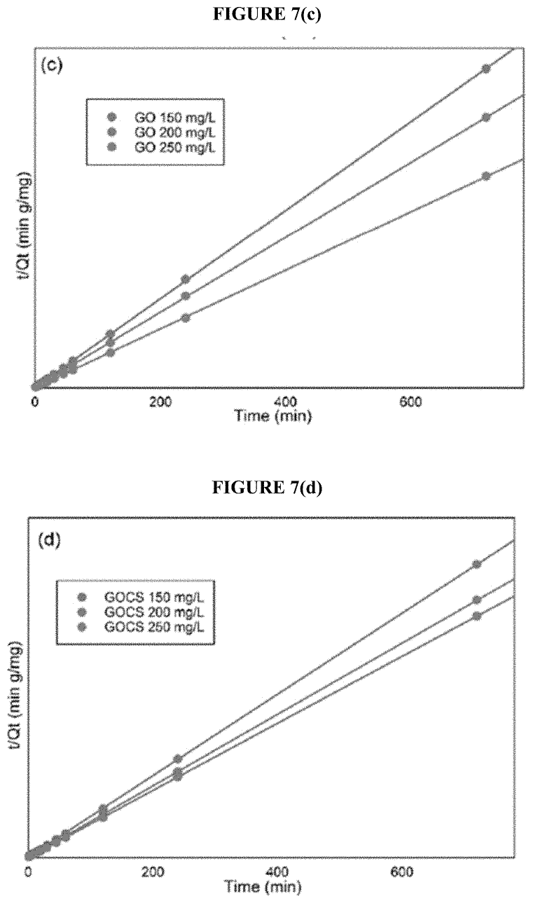

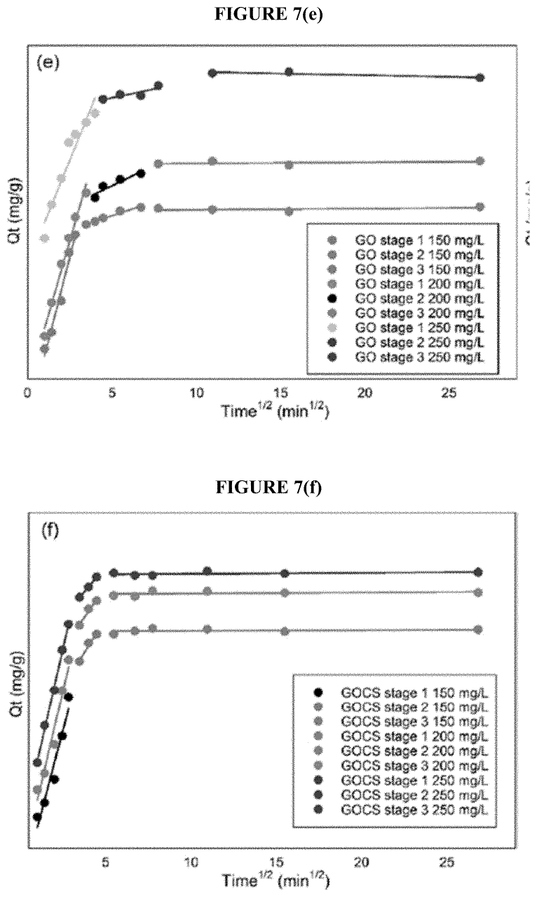

The results of Pb(II) adsorption experiments were fitting to the three kinetics models for GO and GOCS at three different initial concentrations and shown in FIG. 7 and Table 1. As shown in FIG. 7(a-d) and Table 1, the results were in perfect agreement with the Pseudo-Second-Order model with the R² of 0.99 indicating the process of Pb(II) adsorption onto GO and GOCS could be accurately described by Pseudo-Second-Order model. On the other hand, the Qₑ calculated from Pseudo-Second-Order model at 250 mg/L were 232.56 mg/g and 476.19 mg/g which were very closed to the experimental data of 232.69 mg/g and 483.24 mg/g for GO and GOCS, respectively. Moreover, the average R² of these kinetics models were found to follow the order of Pseudo-Second-Order (0.99)>Intra-Particle Diffusion step I (0.97)>Intra-Particle Diffusion step II (0.91)>Pseudo-First-Order (0.85)>Intra-Particle Diffusion step III (0.20). Therefore, all results suggested that the Pseudo-Second-Order model can perfectly describe the process of Pb(II) adsorption onto GO and GOCS indicating the type of adsorption process was chemical adsorption based on the assumption of Pseudo-Second-Order model. Similar results have been reported in the literature.

As shown in FIG. 7(e-f), the process of Pb(II) adsorption onto GO and GOCS was expressed by Intra-Particle Diffusion model in three steps which were mass transfer, intra-particle diffusion, and sorption equilibrium. The mass transfer steps quickly occurred from the external surface to the surface of adsorbents in the first 16 min achieving over 89% and 90% of total Pb(II) adsorption capacity onto GO and GOCS, respectively, which could be attributed to the sufficient anchoring active sites on the surface of GO and GOCS. The second step of intra-particle diffusion occurred from the surface to the inside of pores in adsorbents between 16 to 60 min and achieved about 11% and 10% of the of total Pb(II) adsorption capacity onto GO and GOCS, respectively. Therefore, the Pb(II) adsorption process onto GO and GOCS was a rate limiting step and controlled by intra-particle diffusion.

TABLE 1
Parameters of kinetics models for Pb(II) adsorption onto GO and GOCS.

| | | Initial concentrations (mg/L) | | | | | |
|---|---|---|---|---|---|---|---|
| | | 150 | | 200 | | 250 | |
| Models | Parameters | GO | GOCS | GO | GOCS | GO | GOCS |
| | Qₑ₍ₑₓₚ₎ (mg/g) | 152.17 | 278.67 | 179.65 | 316.53 | 232.69 | 337.8 |
| Pseudo-First-Order | k₁ (min⁻¹) | 0.3406 | 0.1046 | 0.1561 | 0.1032 | 0.1062 | 0.0822 |
| | Qₑ (mg/g) | 87.72 | 287.01 | 79.77 | 303.78 | 72.56 | 323.82 |
| | R² | 0.94 | 0.83 | 0.83 | 0.82 | 0.75 | 0.74 |
| Pseudo-Second-Order | k₂ (mg/g min) | 0.005 | 0.0019 | 0.0031 | 0.002 | 0.0042 | 0.0029 |
| | Qₑ (mg/g) | 153.85 | 277.7 | 181.81 | 322.58 | 232.56 | 333.3 |
| | R² | 0.99 | 0.99 | 0.99 | 0.99 | 0.99 | 0.99 |
| Weber-Morris Intra- | k₃ (mg/g min^{1/2}) | 11.83 | 50.07 | 13.60 | 51.57 | 12.04 | 46.05 |
| Particle Diffusion | Qe (mg/g) | 82.10 | 41.70 | 92.21 | 73.86 | 149.53 | 125.47 |
| | R²-I | 0.95 | 0.94 | 0.98 | 0.96 | 0.92 | 0.99 |
| | R²-II | 0.97 | 0.97 | 0.88 | 0.98 | 0.77 | 0.99 |
| | R²-III | 0.22 | 0.09 | 0.16 | 0.11 | 0.79 | 0.17 |

Adsorption Isotherms

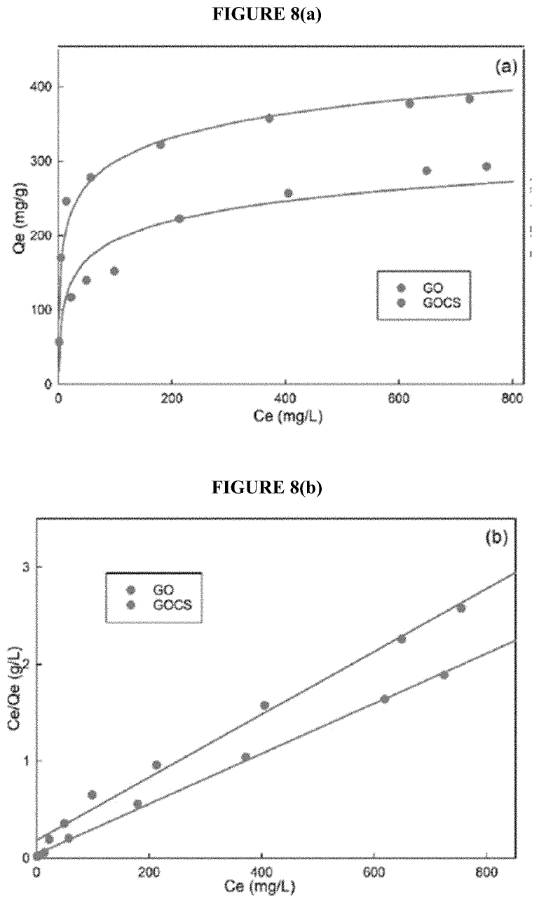

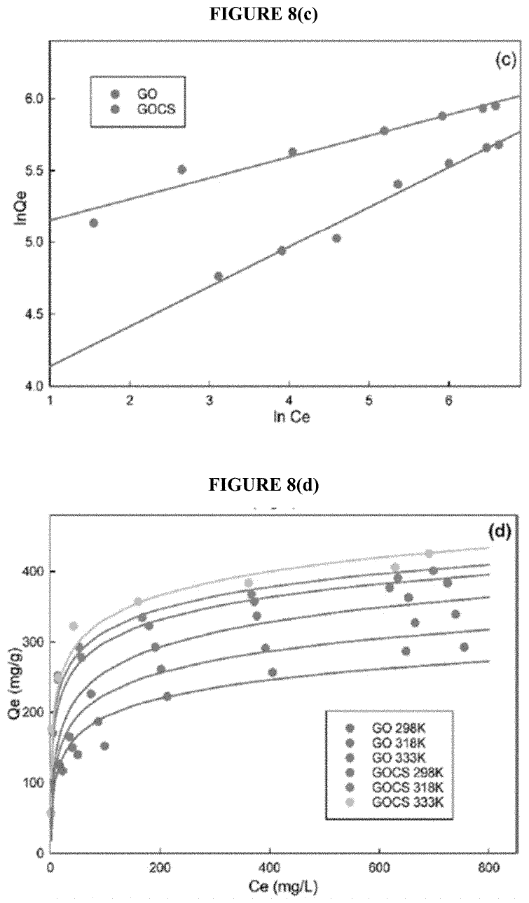

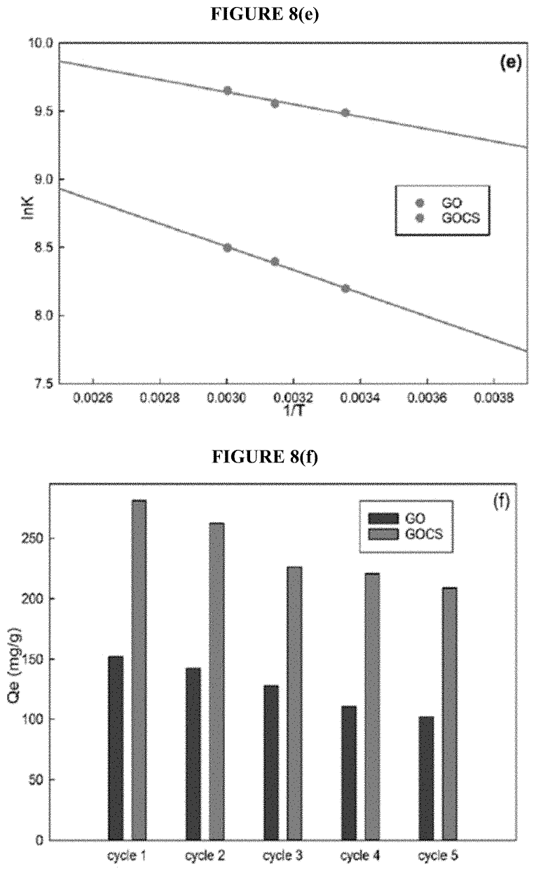

The adsorption isotherm of Pb(II) onto GO and GOCS was conducted by varying the initial Pb(II) concentrations and shown in FIG. 8(a). The experimental results were fitted to the Langmuir (FIG. 8(b)) and Freundlich models (FIG. 8(c)) based on the equations mentioned below. The constants of Langmuir and Freundlich models were calculated and showed in Table 2.

$$\begin{matrix}Langmuir \text{:} \frac{{C}_{e}}{{Q}_{e}} = \frac{1}{{Q}_{max} \cdot {K}_{L}} + \frac{{C}_{e}}{{Q}_{max}} & ( 6 ) \\ Freundlich \text{:} ln {Q}_{e} = \frac{1}{n} ln {C}_{e} + ln {K}_{f} & ( 7 )\end{matrix}$$

where, Qₑ is the adsorption capacity at equilibrium (mg/g); Cₑ is the concentration of Pb(II) solution at equilibrium (mg/L); Qₘₐₓ is the maximum monolayer adsorption capacity (mg/g); K_{L is the Langmuir adsorption constant (L/mg); K}_{f} is the Freundlich adsorption isotherm constant (mg/g). The term 1/n indicates that the heterogeneity of the data distribution of energetic centers and is related to the magnitude of the adsorption driving force.

As shown in FIG. 8(a), the adsorption isotherm curve exhibits a sharp slope indicating high adsorption efficiency at low initial concentrations compared with approximately flat slope indicating the saturation of the adsorption at high concentrations. The maximum adsorption capacity (Qₘₐₓ) of Pb(II) adsorption onto GOCS was 383.4 mg/g showing an increment of 31% compared with the maximum adsorption capacity for GO. This phenomenon indicated that CS₂ modified GO exhibited a significant improvement compared with GO in adsorption capacity. In FIG. 8(b)-(c) and Table 2, the adsorption isotherm results of GO and GOCS fitted better to Langmuir model with the R² of 0.99 compared with Freundlich model with the R² of less than 0.98. These observations suggested that the adsorption mechanism of Pb(II) onto GO and GOCS was monolayer adsorption based on Langmuir model hypothesis. In addition, the maximum adsorption capacities (Qₘₐₓ) corresponding to the complete monolayer coverage for GO and GOCS were 312.5 and 384.6 mg/g, which closely approached to the experimental maximum adsorption capacities of 292.8 mg/g and 383.4 mg/g, respectively. The adsorption coefficient (K_{L}) related to the apparent energy of adsorption was calculated to be 0.0175 and 0.0637 L/mg for GO and GOCS, respectively.

TABLE 2
The constants of Langmuir and Freundlich models.

| | Con- | Value | | R² | |
|---|---|---|---|---|---|
| Models | stants | GO | GOCS | GO | GOCS |
| Langmuir | K_{L} | 0.0175 | 0.0637 | 0.99 | 0.99 |
| | (L/mg) | | | | |
| | Qₘₐₓ | 312.5 | 384.6 | | |
| | (mg/g) | | | | |
| Freundlich | K_{f} | 47.4 | 149.8 | 0.97 | 0.95 |
| | (mg/g) | | | | |
| | 1/n | 0.2773 | 0.1465 | | |

Adsorption Thermodynamics

Adsorption thermodynamic study was conducted to explore the insights onto the inherent energetic changes during the adsorption process at 298 K, 318 K, and 333 K. As shown in FIG. 8(d), the equilibrium adsorption capacity of Pb(II) increased with the increase of the temperature from 298 to 333 K for GO and GOCS, indicating that the process of Pb(II) adsorption onto GO and GOCS could be endothermic in nature.

Three thermodynamics characters, Gibbs Free Energy of Adsorption (ΔG°), the Enthalpy change (ΔH°), and the Entropy change (ΔS°) can provide more information regarding the thermodynamics during the adsorption process. The linear form of Van′t Hoff was utilized to calculate the ΔG°, ΔH°, and ΔS° based on the equations listed below.

$$\begin{matrix}Δ G ° = Δ H ° - T Δ S ° & ( 8 ) \\ Δ G ° = - RT ln K & ( 9 ) \\ K = \frac{( 1000 \times {K}_{L} \times M ) \times C °}{γ} \\ Van ' t Hoff equation \text{:} & ( 10 ) \\ ln K = \frac{Δ S °}{R} - \frac{Δ H °}{RT} & ( 11 )\end{matrix}$$

where, R is the universal constant (8.314 J/mol K); K_{L} is the Langmuir adsorption constant (L/mg), M is the molecular weight of Pb(II) (g/mol), C° is the standard concentration of Pb(II) (1 mol/L), γ is the coefficient of activity (dimensionless).

As shown in FIG. 8(e), the Van′t Hoff equation was plotted with the R² of 0.99 and 0.96 for GO and GOCS, respectively. The thermodynamics characters were calculated and shown in Table 3. The negative value of ΔG° at all different temperatures indicated that the adsorption of Pb(II) onto both of GO and GOCS occurred spontaneously. Moreover, the negative value of ΔG° decreased with the increase of the temperature for both of GO and GOCS implying the stronger adsorption driving force at high temperature. The values of ΔH° for GO and GOCS were 7.1 KJ/mol and 2.78 KJ/mol, respectively, interpreting the endothermic adsorption processes, which was in agreement with the results of FIG. 8(d). The positive ΔS° for Pb(II) adsorption onto GO and GOCS illustrated the enhanced randomness and entropy during the adsorption process.

TABLE 3
Thermodynamic constants for GO and GOCS.

| Materials | T (K) | ΔG° (KJ/mol) | ΔH° (KJ/mol) | ΔS° (J/mol K) |
|---|---|---|---|---|
| | 298 | −20.14 | | |
| GO | 318 | −21.97 | 7.10 | 91.41 |
| | 333 | −23.34 | | |
| | 298 | −23.66 | | |
| GOCS | 318 | −25.50 | 2.78 | 92.01 |
| | 333 | −26.88 | | |

Regeneration Study

Regeneration performance plays an important role to evaluate the quality of the adsorbent. In this study, the regeneration of GO and GOCS was investigated by several cycles of desorption and adsorption. As shown in FIG. 8(f), the adsorption capacity of Pb(II) for both of GO and GOCS decreased with the increase of the number of cycles. In the second regeneration cycle, the adsorption capacities were 142.74 mg/g and 262.38 mg/g, which were 93.75% and 93.26% of the original adsorption capacity for GO and GOCS, respectively. On the 5th regeneration cycle, the adsorption capacities were reduced to 67.05% and 74.26% of the original adsorption capacities for GO and GOCS, respectively. The possible reason is that the complexations were generated by chemical bonding between Pb(II) and oxygen-containing functional groups or sulfur-containing functional groups which the Pb(II) cannot be released completely from the bonding during the desorption process.

Comparison with Other Adsorbents

The adsorption performance of Pb(II) onto GOCS was compared with GO and other adsorbents at similar criteria which the pH, temperature, and dosage ranged from 5 to 6, 293 to 298 K, and 1 to 3 g/L, respectively. As shown in Table 4, most of the reported materials exhibited a limitation in adsorption capacity ranged from 30 to 340 mg/g for Pb(II) removal. The material, CCN-Alg beads, performed a relative high adsorption capacity of 338.98 mg/g under a high initial concentration of 400 mg/L. However, GOCS showed significantly higher adsorption capacity than CCN-Alg beads under a same initial concentration, which indicates GOCS is a more effective adsorbent than CCN-Alg beads and other adsorbents reported in the literature for Pb(II) adsorption.

TABLE 4
Comparison of adsorption capacity with other reported adsorbents.

| | Qₘₐₓ | |
|---|---|---|
| Materials | (mg/g) | Adsorption condition |
| GOCS | 383.4 | pH = 5.5, T = 298K, S/L = 3 g/L |
| GO | 292.8 | pH = 5.5, T = 298K, S/L = 3 g/L |
| ZnO nanoparticles | 114.9 | pH = 6, T = 298K, S/L = 6.25 g/L |
| X-CS/NIPA Am | 172 | pH = 6, T = 298K, S/L = 6.25 g/L |
| CCN-Alg beads | 338.98 | pH = 5.2, T = 298K, C₀ = 400 mg/L |
| p-BNMR @ Fe₃O₄ | 249.5 | pH = 5.5, T = 298K, C₀ = 180 mg/L |
| Geopolymer-alginate- | 142.67 | pH = 5, T = 298K, C₀ = 300 mg/L |
| chitosan | | |
| CCN | 232.56 | pH = 5, T = 293.2K, S/L = 1 g/L |
| Modified beer lees | 29.6 | pH = 4, T = 293.2K, C₀ = 60 mg/L |
| HCl-treated Egyptian | 34.5 | pH = 5.5, T = 298K, C₀ = 100 mg/L |
| Kaolin | | |
| Highly pure Biosilica | 120.4 | pH = 5, T = 298K, S/L = 1 g/L |

Investigation of Adsorption Mechanism

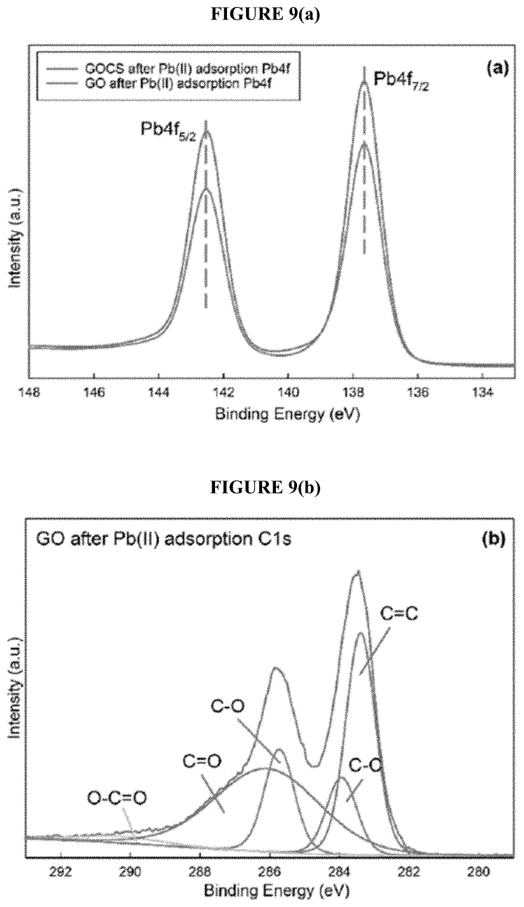

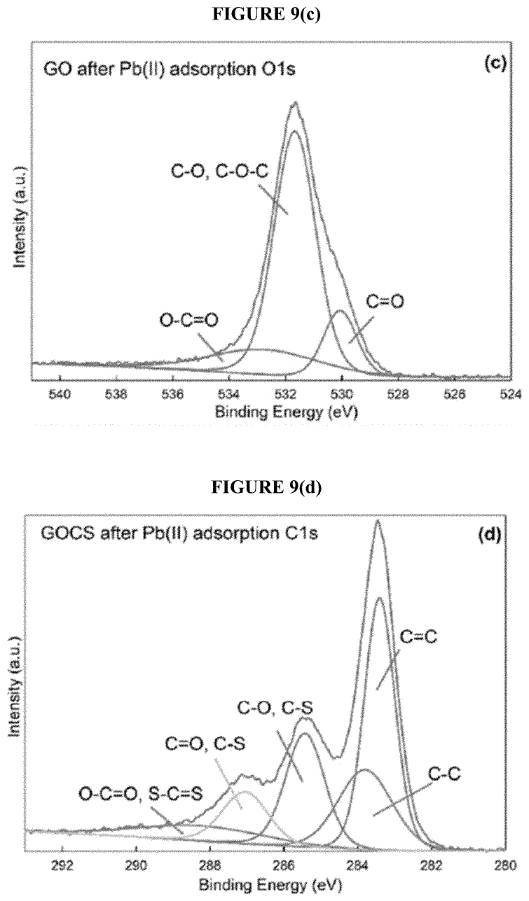

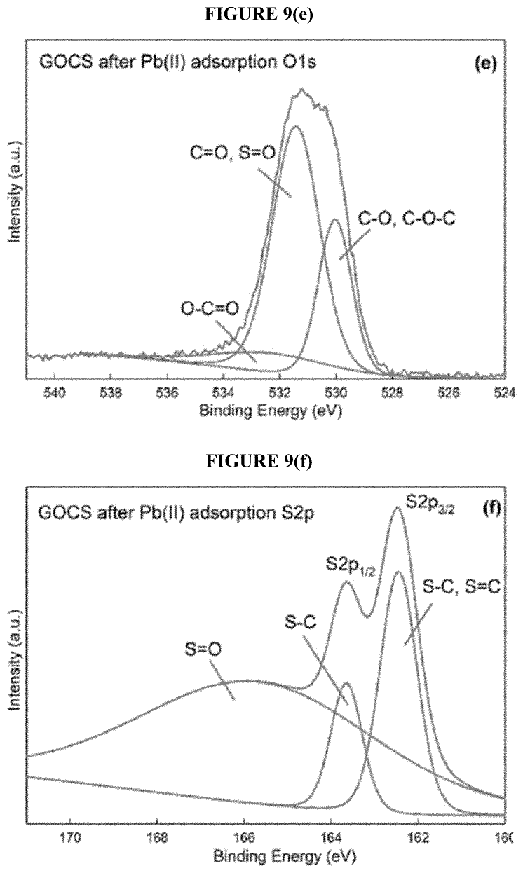

In order to explore more insights into the adsorption mechanism, XPS analysis was conducted to investigate GO and GOCS before and after Pb(II) adsorption. As shown in FIG. 9(a), the spectra of Pb4f in GO and GOCS after Pb(II) adsorption were assigned to two peaks at 137.7 and 142.5 eV corresponding to Pb4f_{7/2} and Pb4f_{5/2}, respectively, which were different from the Pb4f peaks centered at 139.2 and 144.1 eV in the spectra of Pb(NO₃)₂, depicting the interaction between Pb(II) and functional groups on the surface of GO and GOCS during the adsorption process. The spectra of C1s (FIG. 9(b)) in GO after Pb(II) adsorption were deconvoluted to five peaks at 283.4, 283.9, 285.7, 286.1, and 290.1 eV ascribing to C═C, C—C, C—O, C═O, and O—C═O, respectively. The location of C—O, C═O, and O—C═O bonds slightly shift from 285.9, 287.5, and 290.2 eV to 285.7, 286.1, and 290.1 eV, respectively, comparing with those in GO before Pb(II) adsorption. Additionally, the location of C—O, C═O, and O—C═O bonds in the spectrum of O1s (FIG. 9(c)) in GO after Pb(II) adsorption also exhibit the slight shifting from 531.5, 531.9, and 535.4 eV to 530.1, 531.6, and 533.1 eV, respectively, which are consistent with the spectrum of C1s after Pb(II) adsorption. The characteristic bonds of C═C, C—C, C—O and C—S, C═O and S—C═S deconvoluted from the spectrum of C1s (FIG. 9(d)) in GOCS after Pb(II) adsorption exhibiting the reduction of 0.5, 0.8, 0.6, and 0.5 eV in binding energy comparing with those in GOCS, respectively. Similarly, the deconvoluted characteristic bonds of C—O, C═O and S═O, and O—C═O in the spectrum of O1s (FIG. 9(e)) of GOCS after Pb(II) adsorption show a reduction of 0.4, 0.6, and 2 eV in binding energy. Additionally, the two characteristic peaks associated to S2p_{3/2} and S2p_{1/2} in the spectrum of S2p (FIG. 9(f)) in GOCS after Pb(II) adsorption also show the same reduction of 0.6 eV in binding energy. These results could be explained by the reduction in the extra-nuclear electron cloud density of oxygen atoms and sulfur atoms in GO and GOCS which resulted in the decrease of the binding energy of the oxygen- or sulfur-containing bonds. On the other hand, all these observations indicated that the Pb(II) was adsorbed onto the GO and GOCS by the interactions between oxygen- or sulfur-containing functional groups and Pb(II). Therefore, as discussed above, the adsorption mechanism could be described by the consequence of the interactions between Pb(II) species and oxygen-containing functional groups (C—O, C═O, and O—C═O) for GO and oxygen- and sulfur-containing functional groups (C—O, C═O, O—C═O, C—S, and C═S) for GOCS. Moreover, four possible types of interactions were inferred to explain the adsorption mechanism in details including the coordination, electrostatic interactions, cation-pi interactions, and Lewis acid-base interactions. Additionally, the new introduced sulfur-containing functional groups in GOCS probably resulted in the enhanced performance for Pb(II) removal. Thus, GOCS could be an potential and efficient adsorbent for Pb(II) removal from aqueous solutions.

This example shows that GOCS was successfully synthesized by functionalizing GO using CS₂ for the first time using the inventive method. The characterization of GO and GOCS, such as XRD, FTIR, and XPS, confirmed the formation of the oxygen-containing functional groups (C—O, C═O, and O—C═O) in GO and sulfur-containing functional groups (C—S and C═S) in GOCS. The results of pH effects suggested that the highest adsorption capacity for GO and GOCS was observed in the pH range of 5.5 to 5.7. The adsorption capacity for GO and GOCS increased with the increase of the initial Pb(II) concentrations. The equilibrium adsorption capacity for GOCS was 278.67 mg/g at the initial concentration of 150 mg/L showing the 82.2% improvement compared with the equilibrium adsorption capacity of 152.97 mg/g for GO. The maximum adsorption capacity for GOCS was 383.4 mg/g showing an increment of 31% compared with that for GO. These results suggested that the GOCS performed a significant enhancement towards the adsorption of Pb(II) compared with GO. The kinetics and isotherm study suggested the adsorption experimental data fitted perfectly to Pseudo-Second-Order and Langmuir models, respectively. The negative ΔG° and positive ΔH° obtained from thermodynamic study indicated that the adsorption of Pb(II) onto GO and GOCS was spontaneous and endothermic process. The proposed adsorption mechanism suggested that the Pb(II) was successfully adsorbed by the strong interactions, such as coordination, electrostatic interactions, cation-pi interactions, and Lewis acid-base interactions, between Pb(II) species and oxygen- or sulfur-containing functional groups on the surface of GO and GOCS.

For the purpose of understanding the Method for Adsorption of Carbon Disulfide Modified Graphene Oxide for Pb(II), references are made in the text to exemplary embodiments of an Method for Adsorption of Carbon Disulfide Modified Graphene Oxide for Pb(II), only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with an embodiment is included in at least one embodiment. Thus, discussion of the features and advantages, and similar language, throughout this specification may, but do not necessarily, refer to the same embodiment.

1. A method for preparation of carbon disulfide modified graphene oxide comprising:
a. modifying graphene oxide with carbon disulfide; and
b. applying said modified graphene oxide to heavy metals contamination.

2. The method of claim 1 wherein said modifying step introduces a plurality of oxygen-containing functional groups onto the surface of said graphene oxide.

3. The method of claim 2 wherein said plurality of oxygen-containing functional groups comprises functional groups selected from the group consisting of carboxyl, hydroxyl, and epoxy.

4. The method of claim 1 wherein said heavy metal comprises Pb(II).

5. The method of claim 1 where said heavy metal comprises at least one selected from the group consisting of: Ni(II), Cd(II), Cu(II) and Zn(II).

6. The method of claim 4 wherein said Pb(II) is in an aqueous solution.

7. The method of claim 1 wherein said modifying step comprises:
a. mixing a set amount of graphene oxide with NaOH to form a mixture;
b. adding CS₂ into said mixture to create a second mixture;
c. washing said second mixture with DI water until the pH is neutralized to create a neutralized mixture;
d. washing said neutralized mixture a plurality of times with methanol; and
e. drying the methanol washed mixture.

8. The method of claim 7 wherein said mixing step is performed a plurality of times over a 24 to 48 hour period.
